(19) United States
(12) Patent Application Publication
(10) Pub. No.: US 2018/0149096 A1
(43) Pub. Date: May 31, 2018

(54) HYBRID FUEL SYSTEM

(71) Applicant: GHP IP PTY LTD, Petersham, NSW (AU)

(72) Inventors: Elaine JOHNS, Petersham, NSW (AU); Peter FEELEY, Petersham, NSW (AU)

(73) Assignee: GHP IP PTY LTD, Petersham, NSW (AU)

(21) Appl. No.: 15/570,127

(22) PCT Filed: Apr. 27, 2016
(86) PCT No.: PCT/IB2016/000535

§ 371 Date: Oct. 27, 2017

(30) Foreign Application Priority Data
Apr. 27, 2015 (AU) 2015901488
Apr. 27, 2015 (JP) 2015901490

(51) Int. Cl. F02D 19/06; F02D 41/00

(52) U.S. Cl. CPC F02D 19/0644; F02D 2200/0406; F02D 41/0027; F02D 41/0007

(57) ABSTRACT

A hybrid fuel supply system for diesel and other fuel injected internal combustion engines; the system including separate liquid fuel and compressed hydrogen gas sources; and wherein a hydrogen gas supply module calculates of “maps” instant liquid fuel requirements based on engine size and capacity and at least one parameter output from the engine's control unit (ECU) to derive an instant volume of hydrogen gas for addition to the engine's fuel injection system.

### TECHNICAL FIELD

The present invention relates to fuel systems for engines and, more particularly to dynamic pressure and flow control systems for supply of gaseous hydrogen to internal combustion engines, and particularly, though not exclusively, to fuel injected diesel engines.

### BACKGROUND

It is known to augment the liquid hydrocarbon fuel of internal combustion engines with hydrogen. Thus for example PCT/AU2011/000762 by the present applicant discloses a system adapted for supplying complementary hydrogen gas to naturally aspirated petrol engines of vehicles. As in the case of the present invention, PCT/AU2011/000762 discloses a system based on a pressurised hydrogen gas source.

Other systems known in the art, are such as disclosed in U.S. Pat. No. 4,442,801, US2009/0320789, U.S. Pat. No. 6,311,648, U.S. Pat. No. 4,763,610 and U.S. Pat. No. 5,105,773, each of which describes a system based on the on-board electrolysis of water to generate a hydrogen gas supply. Yet other known systems, such as that disclosed in U.S. Pat. No. 7,290,504 derive a hydrogen supply through an on-board processing of a liquid fuel such as ethanol or methanol.

U.S. Pat. No. 4,253,428 does describe a fuel augmentation system for internal combustion engines using gaseous hydrogen from a pressurised source. Although regulators are included in the delivery system, these only operate to maintain a flow level of hydrogen when pressure drops below an acceptable level in the pressurised source tanks. There is no dynamic control of delivery pressure or flow as a function of engine operating conditions.

U.S. Pat. No. 3,906,913 uses on-board hydrogen generation and although mentioning that hydrogen supply could be modulated by a control system, actually teaches against such as system as being undesirably complex.

U.S. Pat. No. 6,655,324 teaches a fuel delivery system with a dual levels of equivalence ratio of fuel to air. The levels control the combination of gasoline and hydrogen as the fuel portion of the equivalence ratios.

Another system for augmenting a liquid fuel with a gaseous one, such as hydrogen, from an on-board pressurised source to the air intake manifold of an engine, is described in U.S. Pat. No. 5,408,957. Pressure and flow of the gaseous fuel are controllable through a control module, but this control is an initial manual setting of a regulator after installation of the system to an optimum engine running when the engine has reached a normal operating temperature.

Yet another system described in U.S. Pat. No. 6,612,269 includes the modulation of the quantity of a mixture of at least two gaseous fuels depending on the sensed composition of those fuels, and supplies the mixture at a constant pressure.

U.S. Pat. No. 4,502,763 discloses a pulsed supply of hydrogen gas to an engine's combustion chamber by pre-charging a chamber of fixed volume at a modulated pressure.

As noted in a number of the above prior art citations, augmentation of hydrogen gas to a liquid fuel internal combustion engine can provide significant economies in the operation of the engine. As well as providing greater fuel economy, hydrogen augmentation can lower significantly particulate emissions in the case of diesel engines.

A problem with applying hydrogen gas to internal combustion engines, and in particular to turbo charged engines lies in the large pressure variations which may obtain in the air intake manifold under varying operating conditions. These pressure variations can prevent a continuous, adequate or optimum supply of hydrogen being available in the intake manifold.

Variation in intake manifold pressure is particularly significant in turbocharged engines in which there is a very large pressure increase once the turbo charger has reached and passed its boost threshold.

A common problem with hydrogen gas augmentation has been the lack of a control system that allows a modulated gas supply relevant to the instant operating conditions of the engine via the fuel injection system of the engine. “Relevant” in this sense implies a calculated and measurable gas flow if the hydrogen is provided efficiently as a supplement to the liquid fuel supplied to the injection system of the engine.

It is noted that compressed hydrogen gas can form an energy source of approximately 320MegaJoules making it a suitable energy supplement when supplied at a “relevant” gas flow rate as an air, hydrogen, liquid fuel mix.

It is an object of the present invention to address or at least ameliorate some of the above disadvantages.

### Notes

The term “comprising” (and grammatical variations thereof) is used in this specification'in the inclusive sense of “having” or “including”, and not in the exclusive sense of “consisting only of”.

The above discussion of the prior art in the Background of the invention, is not an admission that any information discussed therein is citable prior art or part of the common general knowledge of persons skilled in the art in any country.

### SUMMARY OF INVENTION

Accordingly, in a first broad form of the invention, there is provided a hybrid fuel supply system for diesel and other fuel injected internal combustion engines; the system including separate liquid fuel and compressed hydrogen gas sources; and wherein a hydrogen gas supply module calculates of “maps” instant liquid fuel requirements based on engine size and capacity and at least one parameter output from the engine's control unit (ECU) to derive an instant volume of hydrogen gas for addition to the engine's fuel injection system.

Preferably, the hydrogen gas supply module utilises the principles of a fuel injection control unit customised to use in hydrogen gas delivery.

Preferably, the instant volume of added hydrogen gas provided to the injection system causes a drawback of liquid fuel volume by the engine control unit (ECU).

Preferably, the instant volume of hydrogen at the same time reduces a signal voltage of liquid fuel injection by up to 75%.

Preferably, the reduction in signal voltage permits a reduction in liquid fuel in-take calibration causing the engine control unit (ECU) to “draw back” a calculated and measurable percentage of liquid fuel, in effect providing the volumetric space in cylinders of the engine needed to accommodate the added hydrogen gas.

In another broad form of the invention, there is provided a distribution system for supply of gaseous hydrogen to an internal combustion engine; said system including a hydrogen gas supply modulating system; said modulating system responsive to instant operating conditions of said engine.

Preferably, said modulating system modulates pressure of said supply of gaseous hydrogen.

Preferably, said modulating system modulates volumetric flow of said supply of gaseous hydrogen.

Preferably, said gaseous hydrogen supply to said engine is continuous while said engine is running.

Preferably, said gaseous hydrogen is provided from an on-board pressurised gaseous hydrogen primary supply to am air intake manifold of said engine.

Preferably, said on-board pressurised gaseous hydrogen primary supply comprises an exchangeable cylinder of pressurised hydrogen gas.

Preferably, said gaseous hydrogen is provided to said air intake manifold of said engine at a continuously modulated supply pressure; said supply pressure modulated by an actuator controlled variable pressure regulator responsive to instant operating conditions of said engine.

Preferably, said engine is a turbocharged diesel engine.

Preferably, said gaseous hydrogen is provided to said air intake manifold of said engine at any one of at least two different supply pressures and flow rates.

Preferably, said primary supply provides said gaseous hydrogen to a primary regulator; said primary regulator feeding said gaseous hydrogen respectively to at least a first and a second distribution regulator; flow of gaseous hydrogen from said first and second distribution regulator controlled by respective solenoid valves; each of said solenoid valves communicating with a common supply manifold and air intake supply conduit.

Preferably, a first of said at least two different supply pressures is a relatively lower pressure provided to said air intake manifold at lower engine speeds where exhaust gas flow to said turbocharger is below a boost threshold; pressure in said air intake manifold then being below a predetermined pressure.

Preferably, a second of said at least two supply pressures is a relatively higher pressure provided to said air intake manifold at engine speeds where exhaust gas flow has activated said turbocharger and pressure in said air intake manifold is above said predetermined pressure.

Preferably, a first of said two different supply pressures is in the range of 0.5 bar to 0.8 bar.

Preferably, a second of said two different supply pressures is in the range of 0.8 bar to 1.2 bar.

Preferably, said gaseous hydrogen is provided from said primary supply at a pressure range of between 180 bar and 220 bar.

Preferably, said solenoid valves are controlled by a processor; said processor responsive to sensed said instant operating conditions.

Preferably, said instant operating conditions of said engine are determined from pressure in said air intake manifold of said engine.

Preferably, said instant operating conditions are determined from characteristics of exhaust gasses of said engine.

Preferably, said instant operating conditions are determined from a combination of data sensed by an engine management system of said engine and at least a NOX sensor monitoring an exhaust stream of said engine.

Preferably, said system further includes a shut off solenoid valve at said primary supply; said shut off valve maintainable in an open position only when said engine is running.

In a further broad form of the invention, there is provided a method of modulating a supply of gaseous hydrogen to an air intake of an internal combustion engine; said method including the steps of:
a. interposing an actuator controlled continuously variable pressure regulator between a primary pressurised gaseous hydrogen supply and said air intake,
b. providing a control module for control of said continuously variable pressure regulator; said control module comprising a microprocessor and a memory element,
c. providing said control module with data relating to instant operating conditions of said engine.

In still another broad form of the invention, there is provided a method of modulating a supply of gaseous hydrogen to an air intake manifold of an internal combustion engine; said method including the steps of:
a. Splitting gaseous hydrogen from a primary pressurised gaseous hydrogen supply into at least a first supply at a relatively lower pressure and a second supply at a relatively higher pressure,
b. Selecting said first supply at said relatively lower pressure when at least one parameter of instant engine operating conditions is below a predetermined value,
c. Selecting said second supply at said relatively higher pressure when at least one parameter of instant engine operating conditions is at or above said predetermined value.

Preferably, said relatively lower pressure and said relatively higher pressure are controlled by respective pressure regulators.

Preferably, said first supply and said second supply of said gaseous hydrogen are controlled by respective solenoid valves.

Preferably, activation of either one of said respective solenoid valves from a normally closed to an open position is dependent on said at least one parameter of said instant engine operating conditions.

Preferably, said engine is a turbocharged diesel engine.

Preferably, said instant engine operating conditions include any one or a combination of intake manifold pressure, exhaust gas NOₓ level and engine management system data.

In a further broad form of the invention, there is provided a method of increasing the power density of a fuel/air charge inducted into the combustion chambers of an internal combustion engine; said method including modulating pressure and flow of hydrogen to an air intake manifold of said engine; modulation of said pressure and flow responsive to instant operating conditions of said engine.

In another broad form of the invention, there is provided a method of reducing NOₓ emissions from an internal combustion engine; said method including providing a modulated supply of hydrogen from an exchangeable pressurised hydrogen gas cylinder to an air intake manifold of said engine; modulation of pressure and flow of said hydrogen gas responsive to instant operating conditions of said engine.

Preferably, said instant operating conditions of said engine are monitored by any one or a combination of a manifold pressure sensor, an exhaust stream NOₓ level sensor and data from an engine management system of said engine.

In another broad form of the invention, there is provided a gaseous hydrogen injection system for a liquid hydrocarbon fueled internal combustion engine; said system including a gaseous hydrogen fuel diffuser located within an air intake of said engine; said diffuser acting to mix air flow into an intake manifold of said engine with said gaseous hydrogen.

Preferably, said gaseous hydrogen source comprises an exchangeable pressurized gaseous hydrogen cylinder.

Preferably, said gaseous hydrogen fuel diffuser is located proximate an entry of an air intake pipe into an air intake manifold of said engine.

Preferably, said gaseous hydrogen fuel diffuser comprises a free-spinning turbine; said turbine urged into rotation by gaseous hydrogen flowing through said turbine.

Preferably, connection of said gaseous hydrogen fuel diffuser to said exchangeable pressurised gaseous hydrogen cylinder includes a gaseous hydrogen supply modulating system; said modulating system modulating pressure and flow of gaseous hydrogen to said conduit; said modulating system responsive to instant operating conditions of said engine.

Preferably, said gaseous hydrogen is provided to said conduit of said gaseous hydrogen fuel bar at a continuously modulated supply pressure; said supply pressure modulated by an actuator controlled variable pressure regulator responsive to said instant operating conditions of said engine.

Preferably, said gaseous hydrogen is provided to said air intake manifold of said engine at any one of at least two different supply pressures and flow rates.

Preferably, said gaseous hydrogen source provides said gaseous hydrogen to a primary regulator; said primary regulator feeding said gaseous hydrogen respectively to at least a first and a second distribution regulator; flow of gaseous hydrogen from said first and second distribution regulator controlled by respective solenoid valves; each of said solenoid valves communicating with a common supply manifold and air intake supply conduit.

Preferably, a first of said at least two different supply pressures is a relatively lower pressure provided to said conduit of said gaseous hydrogen fuel bar at lower engine speeds at which exhaust gas flow to said turbocharger is below a boost threshold; pressure in said air intake manifold then being below a predetermined pressure.

Preferably, a second of said at least two supply pressures is a relatively higher pressure provided to said conduit of said gaseous hydrogen fuel bar at engine speeds where exhaust gas flow has activated said turbocharger and pressure in said air intake manifold is above said predetermined pressure.

Preferably, a first of said two different supply pressures is in the range of 0.5 bar to 0.8 bar.

Preferably, a second of said two different supply pressures is in the range of 0.8 bar to 1.2 bar.

Preferably, said gaseous hydrogen is provided from said gaseous hydrogen source at a pressure range of between 180 bar and 220 bar.

Preferably, said solenoid valves are controlled by a control module; said control module including a microprocessor and a memory element; said microprocessor responsive to sensed said instant operating conditions.

Preferably, said instant operating conditions of said engine are determined from pressure in said air intake manifold of said engine.

Preferably, said instant operating conditions are determined from characteristics of exhaust gasses of said engine.

Preferably, said instant operating conditions are determined from a combination of data sensed by an engine management system of said engine and at least a NOₓ sensor monitoring an exhaust stream of said engine.

Preferably, said system further includes a shut off solenoid valve at said gaseous hydrogen source; said shut off valve maintainable in an open position only when said engine is running.

Preferably, said engine is a turbocharged diesel engine.

In another broad form of the invention, there is provided a method of providing a gaseous hydrogen to a liquid hydrocarbon fuelled diesel engine; said method including the steps of:
a. Preparing a gaseous hydrogen diffuser; said diffuser comprising a free-spinning turbine,
b. fitting said gaseous hydrogen diffuser within an air intake pipe and proximate an entry of said air intake pipe into an air intake manifold of said engine,
c. connecting a gaseous hydrogen supply conduit to said diffuser and to a pressurised gaseous hydrogen source.

Preferably, connection of said gaseous hydrogen supply conduit to said pressurised gaseous hydrogen source includes an actuator controlled, continuously variable pressure regulator interposed between said pressurised gaseous hydrogen source and said gaseous hydrogen supply conduit.

Preferably, a control module for control of said continuously variable pressure regulator includes a microprocessor and a memory element.

Preferably, said control module is provided with data relating to instant operating conditions of said engine; said instant operating conditions including any one or a combination of data from an air intake manifold pressure sensor, a NOₓ sensor monitoring an exhaust gas flow from said engine, and data provided by an engine management system.

Preferably, said method includes the further steps of:
a. Splitting gaseous hydrogen from a primary pressurised gaseous hydrogen supply into at least a first supply at a relatively lower pressure and a second supply at a relatively higher pressure,
b. Selecting said first supply at said relatively lower pressure when at least one parameter of instant engine operating conditions is below a predetermined value,
c. Selecting said second supply at said relatively higher, pressure when at least one parameter of instant engine operating conditions is at or above said predetermined value.

Preferably, said relatively lower pressure and said relatively higher pressure are controlled by respective pressure regulators.

Preferably, said first supply and said second supply of said gaseous hydrogen are controlled by respective solenoid valves.

Preferably, activation of either one of said respective solenoid valves from a normally closed to an open position is dependent on said at least one parameter of said instant engine operating conditions.

Preferably, said engine is a turbocharged diesel engine.

Preferably, said instant engine operating conditions include any one or a combination of intake manifold pressure, exhaust gas NOX level and engine management system data.

### BRIEF DESCRIPTION OF DRAWINGS

Embodiments of the present invention will now be described with reference to the accompanying drawings wherein:

FIG. 1 is a schematic representation of a first preferred embodiment of a distribution system for gaseous hydrogen supply to an internal combustion engine,

FIG. 1A is a schematic representation of a variation of the first preferred embodiment of FIG. 1,

FIG. 2 illustrates a relationship between a continuously modulated pressure supply of gaseous hydrogen to the engine of FIG. 1, and air intake manifold pressure according to the first preferred embodiment,

FIG. 3 illustrates a relationship between a two-stage modulated pressure supply of gaseous hydrogen to the engine of FIG. 1, and air intake manifold pressure according to a second preferred embodiment,

FIG. 4 is an illustration of a relationship between NOₓ emission levels and a continuously modulated pressure supply of gaseous hydrogen,

FIG. 5 are further schematic views of typical installations of a gaseous hydrogen supply system for an internal combustion engine,

### DESCRIPTION OF EMBODIMENTS

Modulated control of the pressure and/or the flow at which hydrogen gas is supplied to the air intake of an internal combustion engine to supplement a hydrocarbon fuel, is important for the efficient operation of the engine. While it is important in a naturally aspirated engine, it becomes of critical importance in a turbocharged engine.

Turbo chargers make use of the flow of exhaust gasses from an engine to drive a turbine which in turn, typically, drives a centrifugal compressor. At low engine speeds there may be none, or very little output from the compressor due to insufficient exhaust gas flow for the turbo to reach its boost threshold and, in this state, the engine operates effectively as a naturally aspirated engine, drawing air at ambient pressure into the air intake manifold.

To augment the liquid fuel of an internal combustion engine with hydrogen gas via the air intake manifold of the engine, the gas must be supplied at an appropriate pressure and volumetric flow so that it forms a desired proportion of the combined gaseous intake into the combustion chambers. However, an appropriate hydrogen gas pressure suitable for mixing with intake air at low engine speeds, where the engine operates as a naturally aspirated engine, can be completely swamped as the air pressure within the air intake manifold is greatly boosted by the turbocharger.

The present invention addresses this and other operating condition problems by providing a hydrogen gas management system which controls the pressure of the gas supply as a function of the instant operating conditions of the engine.

### First Preferred Embodiment

The present system preferably, though not essentially, provides for gaseous hydrogen to be supplied from a pressurised, exchangeable gas cylinder to a diesel engine. The supply of gaseous hydrogen is optional so that the engine remains operable on just its normal hydrocarbon fuel system. The engine may be a naturally aspirated or a turbocharged or supercharged engine.

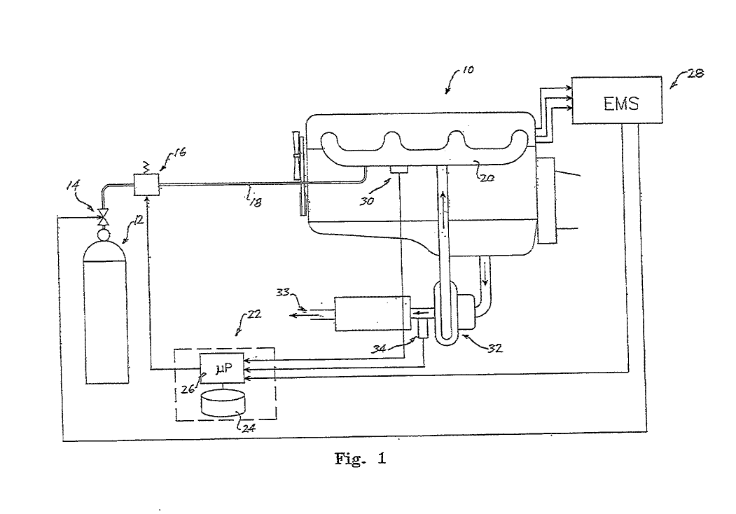

A preferred system of gaseous hydrogen delivery is shown in FIG. 1, in which a diesel engine 10, in this instance a turbocharged diesel engine, is provided with gaseous hydrogen from a pressurised gaseous hydrogen cylinder 12. A normally closed, solenoid shut-off valve 14, which may be under the control of an engine management system 16, opens the valve 14 only when the engine 10 is running.

Gaseous hydrogen supply to the engine 10 is preferably continuously modulated by means of an actuator operated, variable pressure regulator 18, controlled by a control module 20. Control module 20 comprises a microprocessor 22 and memory element 24, and may receive various input data relating to the instant operating conditions of the engine 10. Data may be provided from, for example, a manifold pressure sensor 26 and/or a NOX sensor 28 monitoring the exhaust stream 30. Alternatively, or in addition, data may be provided from the engine management system 16.

Gaseous hydrogen passes from the regulator 18 via conduit 22 to a junction fitting 34 on the air intake pipe 36 of the engine's air intake manifold 38. Gaseous hydrogen is then conducted to a hydrogen gas diffuser element 40 located proximate the entry of the air intake pipe 36 into the air intake manifold 38.

Preferably, the gaseous hydrogen diffuser 40 comprises a small free-spinning turbine urged into spinning motion by the gaseous hydrogen flowing from conduit 22.

Although of lesser importance for stationary diesel generator sets which operate in a relatively narrow rpm range, it is desirable that the supply pressure and flow characteristics of gaseous hydrogen to the engine be optimized according to the instant operating conditions of the engine.

In a turbocharged engine, this control of delivery pressure of the gaseous hydrogen becomes critical. Turbochargers make use of the flow of exhaust gasses from an engine to drive a turbine which in turn, typically, drives a centrifugal compressor. At low engine speeds there may be none, or very little output from the compressor due to insufficient exhaust gas flow for the turbo to reach its boost threshold and, in this state, the engine operates effectively as a naturally aspirated engine, drawing air at ambient pressure into the air intake manifold.

To augment the liquid fuel of an internal combustion engine with gaseous hydrogen via the air intake manifold of the engine, the gas must be supplied at an appropriate pressure and volumetric flow so that it forms a desired proportion of the combined gaseous intake into the combustion chambers. However, an appropriate gaseous hydrogen pressure suitable for mixing with intake air at low engine speeds, where the engine operates as a naturally aspirated engine, can be completely swamped as the air pressure within the air intake manifold is greatly boosted by the turbocharger.

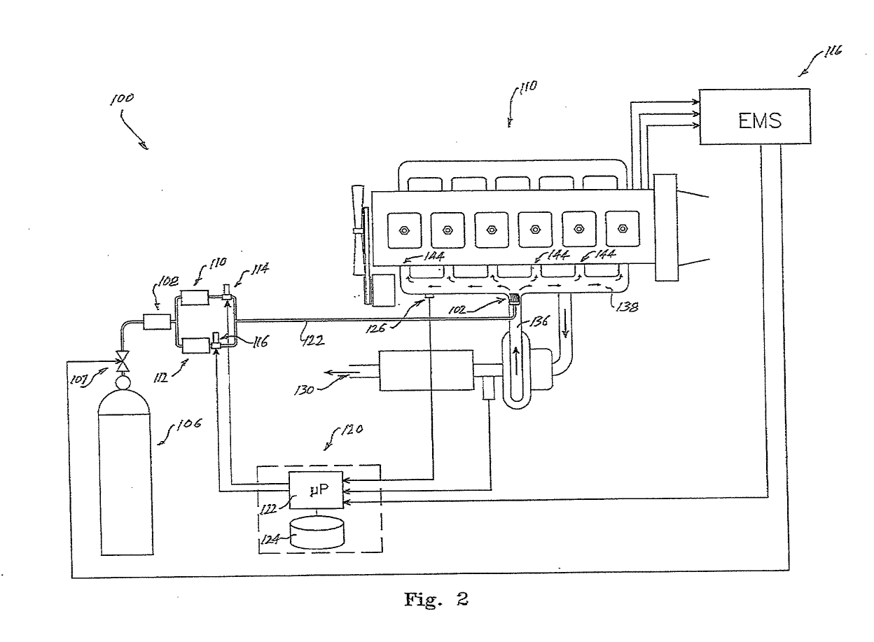

In one arrangement shown in FIG. 1, the microprocessor 22 receives pressure data from the pressure sensor 26 in communication with the air intake manifold 38. In this instance, the microprocessor 22 compares the instantaneous pressure readings provided by the pressure sensor 26 to response curve data stored in the memory element 24 to adjust the delivery pressure of the variable pressure regulator 18. The graph of FIG. 3 illustrates a possible relationship between the pressure of the gaseous hydrogen supply and the pressure within the air intake manifold. As indicated, a significant discontinuity of increase in supply pressure is required from the point at which the turbocharger passes the boost threshold.

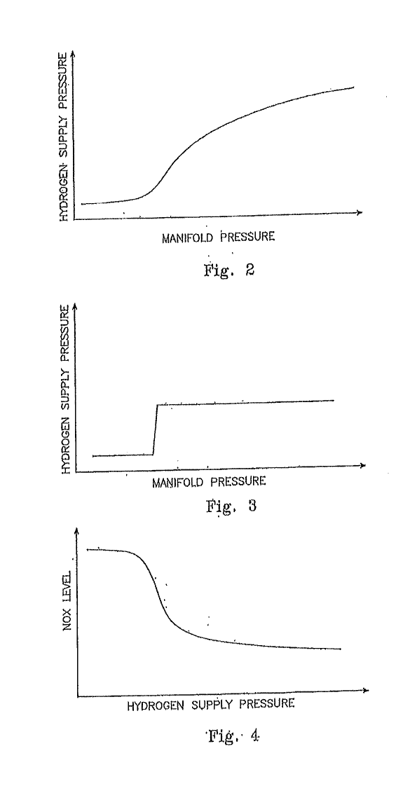

In another arrangement, the composition of the exhaust gasses 30 is monitored by a nitrous oxide (NOX) sensor 28. Because a sufficient supply of gaseous hydrogen can reduce the usage of diesel to almost one third, there is a concomitant reduction in NOX in the exhaust stream 30. Thus a NOX sensor 28 feeding NOX data levels to the microprocessor 22 may be used to optimize the supply pressure of the gaseous hydrogen, in accordance with other relevant parameters of the engine's operation such as for example instant liquid fuel usage, and power output data provided by the engine management system 16. The graph of FIG. 4 shows diagrammatically a possible relationship between NOX emissions and gaseous hydrogen pressure.

### Second Preferred Embodiment

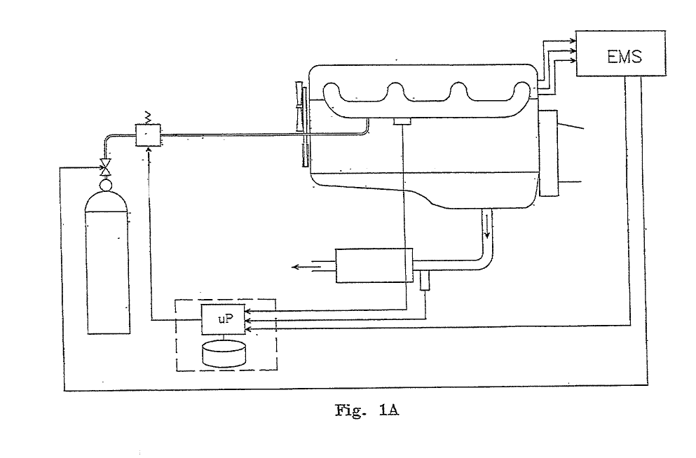

In this preferred embodiment with reference now to FIG. 2, the manner of delivery of gaseous hydrogen to the diffuser element 102 remains as described for the first embodiment above, but in this case the management of the pressure and flow of gaseous hydrogen to the diffuser 102 employs a different system.

As shown in FIG. 2, a gaseous hydrogen management system 100 according to this second preferred embodiment of the invention, provides for the supply of gaseous hydrogen to the diffuser 102, located within the air intake pipe 136 of a turbocharged diesel engine 110, at least at two different supply pressures. The supply of gaseous hydrogen to the engine 110 may again be optional by switching off the gaseous hydrogen supply system; that is the engine can be operated just with its normal hydrocarbon liquid fuel.

In a preferred arrangement, a primary supply of pressurized gaseous hydrogen is again provided in the form of one or more gas cylinders 106, preferably at 200 bar, supplying gaseous hydrogen through a primary pressure regulator 108 set preferably to 8 bar. As described for the first preferred embodiment above, a safety shut-off valve 107 is provided, in this instance interposed between the cylinder/s 106 and the primary regulator 108. Switch 107 defaults to its closed position if the engine is not running. From the primary regulator 108 the supply is split, in this instance through two distribution regulators 110 and 112, into a relatively lower pressure supply and a relatively higher pressure supply.

The two distribution regulators 110 and 112 feed gaseous hydrogen via solenoid controlled valves 114 and 116 to a common distribution manifold 118. From the distribution manifold 118 a conduit 122 feeds gaseous hydrogen at the required pressure, as controlled by either one of the two distribution regulators 110 and 112, to the air intake pipe 102 and thence to the diffuser 102 as described in the first preferred embodiment above.

In this preferred embodiment, the first distribution regulator 110 is set to a delivery pressure of approximately 0.7 bar. This pressure has been found sufficient to supply an adequate flow of gaseous hydrogen of 2 to 3 litres per minute for an engine operating between idle and half throttle.

Preferably the second distribution regulator 112 is set to approximately 1 bar, providing a flow of 3 to 5 litres per minute, adequate for an engine operating between half and full throttle.

In a preferred control arrangement, the switchover of supply from the first lower pressure provided by the first distribution regulator 110, to the higher pressure supplied from the second distribution regulator 112, is controlled by monitoring the instant pressure in the intake manifold 138. A pressure sensor 126 in communication with the intake manifold 138 sends a signal to microprocessor 122 when the pressure rises to a predetermined threshold level. The microprocessor 122 in turn operates on the solenoid valves 114 and 116, to shut gaseous hydrogen flow from the lower pressure distribution regulator 110 and open flow from the higher distribution pressure regulator 112. When pressure drops below the threshold pressure, the valves are reversed to return supply to the lower pressure.

Although the exemplary system of this second preferred embodiment illustrated in FIG. 2 utilizes two distribution regulators, it will be understood that the principle may be put into effect with a series of distribution regulators set to a range of delivery pressures.

Alternatively, or in addition, control of the gaseous hydrogen pressure and flow may be informed by other parameters of instant engine operation as described for the first preferred embodiment above.

In each of the above described embodiments, the effect of a modulated supply of gaseous hydrogen to the air intake manifold 138 via the diffuser 102, is to increase the power density of the air/fuel charge inducted into the compression chambers of an engine. This increase in power density translates into a sensing by the engine management system that less fuel is required for a given power output and consequently the injection charge of the liquid fuel is reduced.

### Third Preferred Embodiment

In a third preferred embodiment with reference to FIG. 1, a turbocharged diesel engine 10 is provided with a variable supply of gaseous hydrogen to supplement its normal hydrocarbon liquid fuel. The gaseous hydrogen is provided as a continuous supply when the engine is running, from a pressurized supply source in the form of an exchangeable pressurized supply cylinder 12, preferably pressurized to around 200 bar. The supply of gaseous hydrogen to the engine 10 is optional, in that it may be switched on or off as required, so that the engine may be operated in a liquid fuel only mode.

A solenoid controlled safety shut off valve 14 is located between the supply cylinder 12 and an actuator-controlled, variable pressure regulator 16, so as to prevent a dangerous build-up of hydrogen gas in the air intake manifold and in the engine when this is stationary. The shut off valve 14 is arranged to default to a closed state if the engine 10 is not running. The variable pressure regulator 16 is connected via conduit 18 to the air intake manifold 20 of engine 10.

The system according to the invention further includes a control module 22, comprising a data storage element 24 and microprocessor 26, which controls the actuator operating the variable pressure regulator 16 within a pressure range of preferably, between 0.5 bar and 1.5 bar, depending on the instant operating conditions of the engine.

The microprocessor 26 may receive data relating to the instant operating condition of the engine 10 from any one, or a combination of, various sensors, and at least in one arrangement may work in conjunction with the engine management system (EMS) 28.

In one arrangement, the microprocessor 26 receives pressure data from a pressure sensor 30 in communication with the air intake manifold 20. In this instance, the microprocessor 26 compares the instantaneous pressure readings provided by the pressure sensor 30 to response curve data stored in the memory element 24 to adjust the delivery pressure of the variable pressure regulator 16. The graph of FIG. 2 illustrates a possible relationship between the pressure of the gaseous hydrogen supply and the pressure within the air intake manifold. As indicated, a significant discontinuity of increase in supply pressure is required from the point at which the turbocharger 32 passes the boost threshold.

In another arrangement, the composition of the exhaust gasses is monitored by a nitrous oxide (NOₓ) sensor 34. Because a sufficient supply of gaseous hydrogen can reduce the usage of diesel to almost one third, there is a concomitant reduction in NOₓ in the exhaust stream 33. Thus a NOₓ sensor 34 feeding NOₓ data levels to the microprocessor 26 may be used to optimize the supply pressure of the gaseous hydrogen, in accordance with other relevant parameters of the engine's operation such as for example instant liquid fuel usage, and power output data provided by the EMS 28. The graph of FIG. 4 shows diagrammatically a possible relationship between NOₓ emissions and hydrogen pressure.

### Fourth Preferred Embodiment

As illustrated in FIG. 1A, the hydrogen supply modulation system described above, may be applied to a non-turbocharged engine. In a naturally aspirated engine, as engine speed increases, greater volumes of air are required with a concomitant need to increase the supply pressure of the hydrogen if an optimum equivalence ratio of hydrogen to air is to be maintained.

In this non-turbocharged arrangement also, hydrogen gas pressure provided to the air intake manifold is continuously modulated according to sensed instant engine operating conditions. Instant operating conditions may either be obtained from “stand alone” sensors such as a pressure sensor 30 at the air intake manifold, a NOₓ sensor in the exhausts stream, or the data from these may be integrated by the microprocessor with data from the engine management system.

### Fifth Preferred Embodiment

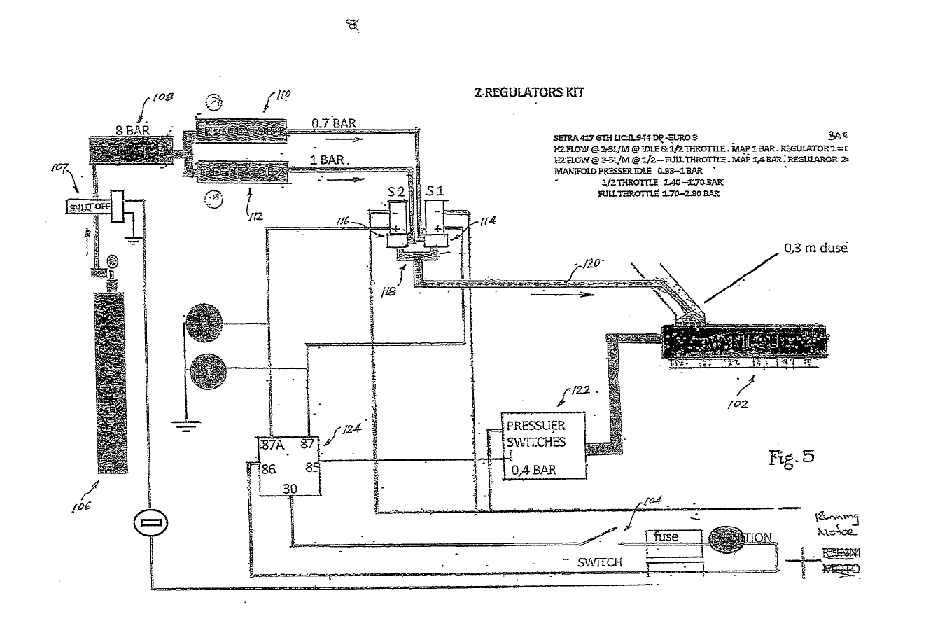

With reference to FIGS. 5, a hydrogen gas management system 100 according to this second preferred embodiment of the invention, provides for the supply of hydrogen gas to the air inlet manifold 102 of a turbocharged diesel engine, at least at two different supply pressures. The supply of hydrogen to the engine may again be optional through control switch 104; that is the engine can be operated only with its normal hydrocarbon liquid fuel.

In a preferred arrangement, a primary supply of pressurized hydrogen gas is again provided in the form of one or more gas cylinders 106, preferably at 200 bar, supplying gaseous hydrogen through a primary pressure regulator 108 set preferably to 8 bar. As described for the first preferred embodiment above, a safety shut-off switch 107 is provided, in this instance interposed between the cylinder/s 106 and the primary regulator 108. Switch 107 defaults to its closed position if the engine is not running. From the primary regulator 108 the supply is split, in this instance through two distribution regulators 110 and 112, into a relatively lower pressure supply and a relatively higher pressure supply.

The two distribution regulators 110 and 112 feed hydrogen via solenoid controlled valves 114 and 116 to a common distribution manifold 118. From the distribution manifold 118 a conduit 120 feeds hydrogen at the required pressure, as controlled by either one of the two distribution regulators 110 and 112, to the air intake manifold 102 of the engine via conduit 120.

In this preferred embodiment, the first distribution regulator 110 is set to a delivery pressure of approximately 0.7 bar. This pressure has been found sufficient to supply an adequate flow of hydrogen of 2 to 3 litres per minute for an engine operating between idle and quarter to half throttle.

Preferably the second distribution regulator 112 is set to approximately 1 bar, providing a flow of 3 to 5 litres per .minute, adequate for an engine operating between half and three quarter throttle.

It will be understood that the pressure and flow rates set out above are by way of example only and will depend on a particular engine's size and operating characteristics.

In a preferred control arrangement, the switchover of supply from the first lower pressure provided by the first distribution regulator 110, to the higher pressure supplied from the second distribution regulator 112, is controlled by monitoring the instant pressure in the intake manifold 102. A pressure sensor 122 in communication with the intake manifold 102 sends a signal to a processor 124 when the pressure rises to a predetermined threshold level. The processor 124 in turn operates on the solenoid valves 114 and 116, to shut hydrogen flow from the lower pressure distribution regulator 110 and open flow from the higher distribution pressure regulator 112. When pressure drops below the threshold pressure, the valves are reversed to return supply to the lower pressure.

Although the exemplary system of this second preferred embodiment illustrated in FIGS. 5 utilizes two. distribution regulators, it will be understood that the principle may be put into effect with a series of distribution regulators set to a range of delivery pressures.

Alternatively, or in addition, control of the hydrogen pressure and flow may be informed by other parameters of instant engine operation as described for the first preferred embodiment above.

As can be seen from the schematic circuit layout of FIG. 5, the hydrogen gas supply system may be selectively activated by closing control switch 104. This activates processor 122 which in turn opens either of the solenoid valves 114 or 116 allowing flow of gas from with either the first or the second regulator 110 or 112. Which solenoid valve is opened depends on the pressure information provided by pressure sensor/switch 122.

In each of the above described embodiments, the effect of a modulated supply of hydrogen to the air intake manifold, is to increase the power density of the air/fuel charge inducted into the compression chambers of an engine. This increase in power density translates into a sensing by the engine management system that less fuel is required for a given power output and consequently the injection charge of the liquid fuel is reduced.

The modulation of the gaseous hydrogen supply pressure and flow as a function of the instant operating conditions of the engine, either as a continuously variable modulation or at least at two predefined levels, provides an improvement in the effect of reducing NOₓ emissions. This is due in the present invention, especially in the case of continuously variable modulation, by the provision of a microprocessor and memory element which permit the integration of engine performance data from the engine management system with the additional sensors at the inlet manifold and the exhaust stream.

The modulation of the gaseous hydrogen supply pressure and flow as a function of the instant operating conditions of the engine, either as a continuously variable modulation or at least at two predefined levels, provides an improvement in the effect of reducing NOX emissions. This is due in the present invention, especially in the case of continuously variable modulation, by the provision of a microprocessor and memory element which permit the integration of engine performance data from the engine management system with the additional sensors at the inlet manifold and the exhaust stream.

### Sixth Preferred Embodiment

In a further preferred embodiment with reference to FIG. 1, a turbocharged diesel engine 10 is provided with a variable supply of gaseous hydrogen to supplement its normal hydrocarbon liquid fuel. The gaseous hydrogen is provided as a continuous supply when the engine is running, from a pressurized supply source in the form of an exchangeable pressurized supply cylinder 12, preferably pressurized to around 200 bar. The supply of gaseous hydrogen to the engine 10 is optional, in that it may be switched on or off as required, so that the engine may be operated in a liquid fuel only mode.

A solenoid controlled safety shut off valve 14 is located between the supply cylinder 12 and an actuator-controlled, variable pressure regulator 16, so as to prevent a dangerous build-up of hydrogen gas in the air intake manifold and in the engine when this is stationary. The shut off valve 14 is arranged to default to a closed state if the engine 10 is not running. The variable pressure regulator 16 is connected via conduit 18 to the air intake manifold 20 of engine 10.

The system according to the invention further includes a control module 22, comprising a data storage element 24 and microprocessor 26, which controls the actuator operating the variable pressure regulator 16 within a pressure range of preferably, between 0.5 bar and 1.5 bar, depending on the instant operating conditions of the engine.

The microprocessor 26 may receive data relating to the instant operating condition of the engine 10 from any one, or a combination of, various sensors, and at least in one arrangement may work in conjunction with the engine management system (EMS) 28.

In one arrangement, the microprocessor 26 receives pressure data from a pressure sensor 30 in communication with the air intake manifold 20. In this instance, the microprocessor 26 compares the instantaneous pressure readings provided by the pressure sensor 30 to response curve data stored in the memory element 24 to adjust the delivery pressure of the variable pressure regulator 16. The graph of FIG. 2 illustrates a possible relationship between the pressure of the gaseous hydrogen supply and the pressure within the air intake manifold. As indicated, a significant discontinuity of increase in supply pressure is required from the point at which the turbocharger 32 passes the boost threshold.

In another arrangement, the composition of the exhaust gasses is monitored by a nitrous oxide (NOₓ) sensor 34. Because a sufficient supply of gaseous hydrogen can reduce the usage of diesel to almost one third, there is a concomitant reduction in NOₓ in the exhaust stream 33. Thus a NOₓ sensor 34 feeding NOₓ data levels to the microprocessor 26 may be used to optimize the supply pressure of the gaseous hydrogen, in accordance with other relevant parameters of the engine's operation such as for example instant liquid fuel usage, and power output data provided by the EMS 28. The graph of FIG. 4 shows diagrammatically a possible relationship between NOₓ emissions and hydrogen pressure.

### Seventh Preferred Embodiment

As illustrated in FIG. 1A, the hydrogen supply modulation system described above, may be applied to a non-turbocharged engine. In a naturally aspirated engine, as engine speed increases, greater volumes of air are required with a concomitant need to increase the supply pressure of the hydrogen if an optimum equivalence ratio of hydrogen to air is to be maintained.

In this non-turbocharged arrangement also, hydrogen gas pressure provided to the air intake manifold is continuously modulated according to sensed instant engine operating conditions. Instant operating conditions may either be obtained from “stand alone” sensors such as a pressure sensor 30 at the air intake manifold, a NOₓ sensor in the exhausts stream, or the data from these may be integrated by the microprocessor with data from the engine management system (EMS).

### Eighth Preferred Embodiment

In this preferred embodiment with reference now to FIG. 2, the manner of delivery of gaseous hydrogen to the diffuser element 102 remains as described for the first embodiment above, but in this case the management of the pressure and flow of gaseous hydrogen to the diffuser 102 employs a different system.

As shown in FIG. 2, a gaseous hydrogen management system 100 according to this second preferred embodiment of the invention, provides for the supply of gaseous hydrogen to the diffuser 102, located within the air intake pipe 136 of a turbocharged diesel engine 110, at least at two different supply pressures. The supply of gaseous hydrogen to the engine 110 may again be optional by switching off the gaseous hydrogen supply system; that is the engine can be operated just with its normal hydrocarbon liquid fuel.

In a preferred arrangement, a primary supply of pressurized gaseous hydrogen is again provided in the form of one or more gas cylinders 106, preferably at 200 bar, supplying gaseous hydrogen through a primary pressure regulator 108 set preferably to 8 bar. As described for the first preferred embodiment above, a safety shut-off valve 107 is provided, in this instance interposed between the cylinder/s 106 and the primary regulator 108. Switch 107 defaults to its closed position if the engine is not running. From the primary regulator 108 the supply is split, in this instance through two distribution regulators 110 and 112, into a relatively lower pressure supply and a relatively higher pressure supply.

The two distribution regulators 110 and 112 feed gaseous hydrogen via solenoid controlled valves 114 and 116 to a common distribution manifold 118. From the distribution manifold 118 a conduit 122 feeds gaseous hydrogen at the required pressure, as controlled by either one of the two distribution regulators 110 and 112, to the air intake pipe 102 and thence to the diffuser 102 as described in the first preferred embodiment above.

In this preferred embodiment, the first distribution regulator 110 is set to a delivery pressure of approximately 0.7 bar. This pressure has been found sufficient to supply an adequate flow of gaseous hydrogen of 2 to 3 litres per minute for an engine operating between idle and half throttle.

Preferably the second distribution regulator 112 is set to approximately 1 bar, providing a flow of 3 to 5 litres per minute, adequate for an engine operating between half and full throttle.

In a preferred control arrangement, the switchover of supply from the first lower pressure provided by the first distribution regulator 110, to the higher pressure supplied from the second distribution regulator 112, is controlled by monitoring the instant pressure in the intake manifold 138. A pressure sensor 126 in communication with the intake manifold 138 sends a signal to microprocessor 122 when the pressure rises to a predetermined threshold level. The microprocessor 122 in turn operates on the solenoid valves 114 and 116, to shut gaseous hydrogen flow from the lower pressure distribution regulator 110 and open flow from the higher distribution pressure regulator 112. When pressure drops below the threshold pressure, the valves are reversed to return supply to the lower pressure.

Although the exemplary system of this second preferred embodiment illustrated in FIG. 2 utilizes two distribution regulators, it will be understood that the principle may be put into effect with a series of distribution regulators set to a range of delivery pressures.

Alternatively, or in addition, control of the gaseous hydrogen pressure and flow may be informed by other parameters of instant engine operation as described for the first preferred embodiment above.

### Ninth Preferred Embodiment

With reference to FIGS. 5, a hydrogen gas management system 100 according to this further preferred embodiment of the invention, provides for the supply of hydrogen gas to the air inlet manifold 102 of a turbocharged diesel engine, at least at two different supply pressures. The supply of hydrogen to the engine may again be optional through control switch 104; that is the engine can be operated only with its normal hydrocarbon liquid fuel.

In a preferred arrangement, a primary supply of pressurized hydrogen gas is again provided in the form of one or more gas cylinders 106, preferably at 200 bar, supplying gaseous hydrogen through a primary pressure regulator 108 set preferably to 8 bar. As described for the first preferred embodiment above, a safety shut-off switch 107 is provided, in this instance interposed between the cylinder/s 106 and the primary regulator 108. Switch 107 defaults to its closed position if the engine is not running. From the primary regulator 108 the supply is split, in this instance through two distribution regulators 110 and 112, into a relatively lower pressure supply and a relatively higher pressure supply.

The two distribution regulators 110 and 112 feed hydrogen via solenoid controlled valves 114 and 116 to a common distribution manifold 118. From the distribution manifold 118 a conduit 120 feeds hydrogen at the required pressure, as controlled by either one of the two distribution regulators 110 and 112, to the air intake manifold 102 of the engine via conduit 120.

In this preferred embodiment, the first distribution regulator 110 is set to a delivery pressure of approximately 0.7 bar. This pressure has been found sufficient to supply an adequate flow of hydrogen of 2 to 3 litres per minute for an engine operating between idle and quarter to half throttle.

Preferably, the second distribution regulator 112 is set to approximately 1 bar, providing a flow of 3 to 5 litres per minute, adequate for an engine operating between half and three quarter throttle.

It will be understood that the pressure and flow rates set out above are by way of example only and will depend on a particular engine's size and operating characteristics.

In a preferred control arrangement, the switchover of supply from the first lower pressure provided by the first distribution regulator 110, to the higher pressure supplied from the second distribution regulator 112, is controlled by monitoring the instant pressure in the intake manifold 102. A pressure sensor 122 in communication with the intake manifold 102 sends a signal to a processor 124 when the pressure rises to a predetermined threshold level. The processor 124 in turn operates on the solenoid valves 114 and 116, to shut hydrogen flow from the lower pressure distribution regulator 110 and open flow from the higher distribution pressure regulator 112. When pressure drops below the threshold pressure, the valves are reversed to return supply to the lower pressure.

Although the exemplary system of this third preferred embodiment illustrated in FIGS. 5 utilizes two distribution regulators, it will be understood that the principle may be put into effect with a series of distribution regulators set to a range of delivery pressures.

Alternatively, or in addition, control of the hydrogen pressure and flow may be informed by other parameters of instant engine operation as described for the first preferred embodiment above.

As can be seen from the schematic circuit layout of FIG. 5, the hydrogen gas supply system may be selectively activated by closing control switch 104, This activates processor 122 which in turn opens either of the solenoid valves 114 or 116 allowing flow of gas from with either the first or the second regulator 110 or 112. Which solenoid valve is opened depends on the pressure information provided by pressure sensor/switch 122.

In each of the above described embodiments, the effect of a modulated supply of hydrogen to the air intake manifold, is to increase the power density of the air/fuel charge inducted into the compression chambers of an engine. This increase in power density translates into a sensing by the engine management system that less fuel is required for a given power output and consequently the injection charge of the liquid fuel is reduced.

The modulation of the gaseous hydrogen supply pressure and flow as a function of the instant operating conditions of the engine, either as a continuously variable modulation or at least at two predefined levels, provides an improvement in the effect of reducing NOₓ emissions. This is due in the present invention, especially in the case of continuously variable modulation, by the provision of a microprocessor and memory element which permit the integration of engine performance data from the engine management system with the additional sensors at the inlet manifold and the exhaust stream.

### Tenth Preferred Embodiment

### Mapped Control of Variable Flow Rates

With particular reference to the embodiments above, in a further aspect of the invention, the supply of hydrogen gas is effectively mapped to the instant requirements of the engine as a calculated and measurable amounts of gas, in line with engine size and capacity. As alluded to in the Background section above, no standardised and/or set gas flow rate can meet the optimum energy input requirements of an engine in operation over variable throttle positions as openings and/or RPMs.

The present invention provides the development of a hydrogen fuel “map” to create the relevant or appropriate hydrogen gas supplement to an internal combustion engine. The “map” utilises the principles of a fuel injection control unit customised for use in hydrogen gas delivery.

As described for the first preferred embodiment above, the hydrogen gas electronic control unit (ECU) 22 of FIG. 1, includes circuitry and a central processor module with memory and a software program for the calculation of optimum variable gas volume and flow ratios upon demand of an engine during its operating cycles.

The hydrogen ECU is responsive to a selection of input parameters. These include the engine's capacity and its fuel consumption. The algorithm operating in the ECU further includes the following parameters:
a. Diesel molecules in liquid form weigh 230 grams per Mole (in atomised form 2.16 grams per Mole)
b. Hydrogen in gaseous form weighs 2.01 grams per Mole.

Thus hydrogen in the ration of 1.5% to diesel at 1% can be used as a substitute, noting that hydrogen energy is approximately 120 Mega Joules compared with diesel at 34.95 Mega Joules.

To calculate the required volume and flow ratios then for a four cylinder engine of 3 litre capacity, the hydrogen ECU proceeds as follows:
Cubic centimetre capacity per cylinder is 3000/4=750 cc
Air density at 20degrees C.=1.2 Kg/M³ or approximately 1 mg/cm³

The diesel stoichiometric ratio=15 parts air to 1 part diesel, thus 15 mg of air to 1 mg of diesel is used in combustion burn.

Thus an engine with 750 cc capacity per cylinder requires 705 mg of air to 45 mg of diesel at full throttle opening per piston stroke.
At 4000 rpm, 1 piston stroke=15 ms
For a four cylinder engine=16000 piston strokes per minute =16000 piston strokes per minute @45 mg per piston stroke =675 mg of diesel fuel per minute at full throttle, or
0.675L/minute.

The system of the present embodiment delivers a calculated volume of hydrogen as a function of the instant volume of diesel which would, in the absence of hydrogen augmentation, have been provided to the fuel injection system as mandated by the original equipment manufacturer (OEM) engine control unit (ECU) based on the instant throttle position.

The addition of the calculated volume of hydrogen provided to the fuel injection system in effect causes a proportionate reduction in the volume of diesel required as detected by the ECU.

The “relevant” hydrogen gas addition on a variable scale makes the engine a hybrid fuel engine, able to operate on dual energy sources. This arrangement is particularly favourable commercially as it provides an economical supplement to a more expensive (diesel) energy source.

It may be noted that the mapping of the hydrogen supply to the diesel fuelling of an engine provides increased effective fuelling of the engine at times of high rpm and when under load. Without the mapping provided by the hydrogen ECU system of the present embodiment, a constant supply of hydrogen gas would result in spasmodic “relevance” to the engine's operation.

Previously, hydrogen augmentation systems have utilised variable solenoid valves in line with throttle position openings, typically using stepper motor valves, but such a system is still restrictive since there is no calculated and measurable relevance to the engine's size and capacity. While such solenoid valves allow for variable flow rate, they typically operate at “standard” flow rates of, for example, full, ¾, ½ and ¼ opening. They are not capable of scaling for “engine relevance”.

The system of the present embodiment thus “maps” the volume of hydrogen to be provided to the injection system, to the engine's instant operating status and at the same time reduces the signal voltage of liquid fuel injection by up to 75%, permitting a reduction in the liquid fuel in-take calibration. This causes the original equipment manufacturer (OEM) engine control unit (ECU) to “drawback” a calculated and measurable percentage of liquid fuel, in effect providing the volumetric space in the cylinders of the engine needed to accommodate the added hydrogen gas.

It will be understood that without the drawback of liquid fuel there can be no physical space for the addition of hydrogen gas due to cylinder volume limitations, since once the stoichiometric volume of air/fuel is achieved a cylinder is essentially full, and the rejection (holding out) of the addition of hydrogen gas can result.

In the present embodiment, the system includes a second electronic regulator prior to the hydrogen gas injector to ensure that the mapped flow rates passing through the injector remain “relevant” to the instant operating parameters of the engine.

1. A hybrid fuel supply system for diesel and other fuel injected internal combustion engines; the system including separate liquid fuel and compressed hydrogen gas sources; and wherein a hydrogen gas supply module calculates of “maps” instant liquid fuel requirements based on engine size and capacity and at least one parameter output from the engine's control unit (ECU) to derive an instant volume of hydrogen gas for addition to the engine's fuel injection system.

2. The system of claim 1 wherein the hydrogen gas supply module utilises the principles of a fuel injection control unit customised to use in hydrogen gas delivery.

3. The system of claim 1 wherein the instant volume of added hydrogen gas provided to the injection system causes a drawback of liquid fuel volume by the engine control unit (ECU).

4. The system of claim 3 wherein the instant volume of hydrogen at the same time reduces a signal voltage of liquid fuel injection by up to 75%.

5. The system of claim 3 wherein the reduction in signal voltage permits a reduction in liquid fuel in-take calibration causing the engine control unit (ECU) to “draw back” a calculated and measurable percentage of liquid fuel, in effect providing the volumetric space in cylinders of the engine needed to accommodate the added hydrogen gas.

6. A distribution system for supply of gaseous hydrogen to an internal combustion engine; said system including a hydrogen gas supply modulating system; said modulating system responsive to instant operating conditions of said engine.

7. The distribution system of claim 6 wherein said modulating system modulates pressure of said supply of gaseous hydrogen.

8. The distribution system of claim 6 wherein said modulating system modulates volumetric flow of said supply of gaseous hydrogen.

9. The distribution system of claim 6 wherein said gaseous hydrogen supply to said engine is continuous while said engine is running.

10. The distribution system of claim 6 wherein said gaseous hydrogen is provided from an on-board pressurized gaseous hydrogen primary supply to an air intake manifold of said engine.

11. The distribution system of claim 10 wherein said on-board pressurised gaseous hydrogen primary supply comprises an exchangeable cylinder of pressurised hydrogen gas.

12. The distribution system of claim 6 wherein said gaseous hydrogen is provided to said air intake manifold of said engine at a continuously modulated supply pressure; said supply pressure modulated by an actuator controlled variable pressure regulator responsive to instant operating conditions of said engine.

13. The distribution system of claim 1 wherein said engine is a turbocharged diesel engine.

14. The distribution system of claim 6 wherein said gaseous hydrogen is provided to said air intake manifold of said engine at any one of at least two different supply pressures and flow rates.

15. The distribution system of claim 14 wherein said primary supply provides said gaseous hydrogen to a primary regulator; said primary regulator feeding said gaseous hydrogen respectively to at least a first and a second distribution regulator; flow of gaseous hydrogen from said first and second distribution regulator controlled by respective solenoid valves; each of said solenoid valves communicating with a common supply manifold and air intake supply conduit.

16. The distribution system of claim 14 wherein a first of said at least two different supply pressures is a relatively lower pressure provided to said air intake manifold at lower engine speeds where exhaust gas flow to said turbocharger is below a boost threshold; pressure in said air intake manifold then being below a predetermined pressure.

17. The distribution system of claim 14 wherein a second of said at least two supply pressures is a relatively higher pressure provided to said air intake manifold at engine speeds where exhaust gas flow has activated said turbocharger and pressure in said air intake manifold is above said predetermined pressure.

18. The distribution system of claim 14 wherein first of said two different supply pressures is in the range of 0.5 bar to 0.8 bar.

19. The distribution system of claim 14 wherein a second of said two different supply pressures is in the range of 0.8 bar to 1.2 bar.

20. The distribution system of claim 6 wherein said gaseous hydrogen is provided from said primary supply at a pressure range of between 180 bar and 220 bar.

21.-64. (canceled)
